(19) United States
(12) Patent Application Publication
(10) Pub. No.: US 2025/0100215 A1
(43) Pub. Date: Mar. 27, 2025

(54) HYBRID ADDITIVE MANUFACTURING DEVICE AND MANUFACTURING METHOD OF SECONDARY FUNCTIONAL MATERIAL FILLED LATTICE STRUCTURES

(71) Applicant: National Taiwan University of Science and Technology, Taipei (TW)

(72) Inventors: Jeng-Ywan Jeng, Taipei (TW); Mayur Jiyalal Prajapati, Taipei (TW); Ajeet Kumar, Taipei (TW)

(21) Appl. No.: 18/411,004

(22) Filed: Jan. 11, 2024

(30) Foreign Application Priority Data
Sep. 26, 2023 (TW) 112136701

(51) Int. Cl. B29C 64/209; B29C 64/118; B29C 64/232; B29C 64/236; B29C 64/241; B29C 64/245; B29C 64/295; B29C 64/30; B29K 101/12; B29K 105/04; B33Y 10/00; B33Y 30/00; B33Y 40/00; B33Y 80/00

(52) U.S. Cl. CPC B29C 64/209; B29C 64/118; B29C 64/232; B29C 64/236; B29C 64/241; B29C 64/245; B29C 64/295; B29C 64/30; B33Y 10/00; B33Y 30/00; B33Y 40/00; B33Y 80/00; B29K 2101/12; B29K 2105/046

(57) ABSTRACT

Provided are a hybrid additive manufacturing device and a hybrid additive manufacturing method of secondary functional material filled lattice structures. The hybrid additive manufacturing device of secondary functional material filled lattice structures includes a frame, a main nozzle assembly, a plurality of auxiliary nozzle assemblies, a coupler, an operating platform and a movable mechanism. The coupler can be driven by the movable mechanism to connect the main nozzle assembly and move the main nozzle assembly to the operating platform to generate an support-free open-cell lattice structure formed by thermoplastic materials firstly; and then, the coupler can return the main nozzle assembly to the frame and connect one of the auxiliary nozzle assemblies to fill secondary functional materials into a lattice cavity inside the lattice structure, so that the lattice structure forms a closed-cell lattice structure.

### CROSS REFERENCE TO RELATED APPLICATIONS

The present application claims the benefit of Taiwanese Patent Application No. 112136701 on Sep. 26, 2023, the contents of which are incorporated herein by reference in their entirety.

### BACKGROUND

### Technical Field

The present invention relates to the field of additive manufacturing, and particularly relates to a hybrid additive manufacturing device and a hybrid additive manufacturing method of secondary functional material filled lattice structures, which relates to a material extrusion process to manufacture a closed-cell lattice structure filled with auxiliary functional materials in a single process using a multi-tool hybrid fused filament manufacturing system.

### Description of Related Art

According to the addictive manufacturing technology, also known as 3D printing technology, structures such as lattice structures, honeycomb structures or biomimetic structures that are complex in structure and tight in geometric clearance and would be difficult to manufacture using traditional manufacturing technologies (such as injection molding and CNC machining) can be manufactured. Therefore, in recent years, the additive manufacturing technology has replaced the traditional manufacturing technologies to become the current development trend of the industry.

While additive manufacturing (AM) makes it possible to manufacture complex honeycomb lattice structures with tight geometric tolerances, conventional lattice structures are usually manufactured using only a single material. Therefore, the enhancement of mechanical properties of lattice structures becomes limited, and a single material cannot effectively improve the mechanical properties and the functional properties such as vibration and sound damping of the lattice structure.

On the other hand, when a multi-material lattice structure is to be manufactured, the manufacturing of a composite structure of the multi-material lattice structure often involves multiple processes, consumes a lot of time costs and labor costs, and causes more problems generated in transportation and manufacturing processes when more processes are provided, thereby relatively affecting the yield of finished products and the shipping efficiency. Therefore, how to reduce related manufacturing processes in the case of providing a multi-material lattice structure is one of the urgent issues to be solved by workers and scholars in the field of additive manufacturing.

### SUMMARY

A main objective of the present invention is to provide a hybrid additive manufacturing device and a hybrid additive manufacturing method of secondary functional material filled lattice structures, which can create a closed-cell lattice structure filled with secondary functional materials to enhance the energy absorption and dissipation of an impact energy.

Another objective of the present invention to provide a hybrid additive manufacturing device and a hybrid additive manufacturing method of secondary functional material filled lattice structures, which can combine additive manufacturing and secondary material filling processes into a manufacturing process, so that the decentralization of the manufacturing process is promoted, thereby reducing the lead time of manufacturing and improving the manufacturing yield.

To achieve the above objectives of the present invention, there is provided a hybrid additive manufacturing device of secondary functional material filled lattice structures, comprising: a frame having an operating space inside; a main nozzle assembly detachably arranged on the frame and configured to be driven to eject a thermoplastic material; a plurality of auxiliary nozzle assemblies detachably arranged on the frame respectively and configured to be driven to eject at least one secondary functional material; a coupler movably arranged in the operating space of the frame, where the coupler has a first connecting unit, and the main nozzle assembly and the auxiliary nozzle assemblies each have a second connecting unit corresponding to the first connecting unit of the coupler, and the coupler is driven to move by the first connecting unit in combination with the second connecting unit of one of the main nozzle assembly or the auxiliary nozzle assemblies; an operating platform arranged in the operating space of the frame; and a movable mechanism arranged on the frame, connected to the coupler and a carrying device, and configured to allow the coupler and the operating platform to move relative to each other in a three-dimensional direction; thus, the coupler can be driven by the movable mechanism to connect the main nozzle assembly and move the main nozzle assembly to the operating platform to generate an support-free lattice structure formed by a thermoplastic material; and then the coupler can be driven by the movable mechanism to return the main nozzle assembly to the frame and connect one of the auxiliary nozzle assemblies to move the one to the operating platform to fill at least a secondary functional material into a lattice cavity inside the lattice structure, so that the lattice structure forms a closed-cell lattice structure.

In one embodiment, the main nozzle assembly has a body, a feed inlet, a first heat dissipation unit, a heating unit and a nozzle head; the feed inlet is formed on the body and configured to fill the thermoplastic material; the first heat dissipation unit is arranged on one side of the body, and the inside of the first heat dissipation unit is communicated with the feed inlet; the heating unit is arranged on one side of the first heat dissipation unit opposite to the feed inlet, and communicated with the inside of the first heat dissipation unit; and the nozzle head is adjacent to the heating unit, and configured to be driven to eject the thermoplastic material that enters through the feed inlet and is heated by the heating unit.

In one embodiment, the main nozzle assembly further has a second fan and a hollow airflow channel; the second fan is arranged on one side of the body opposite to the first heat dissipation unit; and the airflow channel is arranged on the body, one end of the airflow channel is communicated with the second fan, and the other end is adjacent to the nozzle head.

In one embodiment, one of the auxiliary nozzle assemblies has a body, a roller assembly, a motor, a feed pipe and a nozzle head; the roller assembly is rotatably arranged on one side of the body; the motor is arranged on the body and adjacent to the roller assembly, and configured to be driven to drive the roller assembly to rotate in a direction of rotation; the feed pipe is approximately curved around the roller assembly, and one end of the feed pipe is connected to a fluid source so that the fluid source can fill a fluid material into the feed pipe; and the nozzle head is arranged on the body, communicated with the other end of the feed pipe opposite to the fluid source, and configured to be driven to eject the fluid material in the feed pipe.

In one embodiment, one of the auxiliary nozzle assemblies has an injection pipe unit, a plurality of feed pipes, a driving unit and a nozzle head; the injection pipe unit has a pipe body and a piston, the pipe body has a feed space inside, and one end of the piston extends into the feed space of the pipe body; one ends of the feed pipes are connected to at least one feed source, and the other ends are respectively connected to the feed space of the pipe body, so that the feed source can inject at least one foam material into the feed space of the pipe body along the feed pipes; the driving unit is connected to the piston, and configured to drive the piston to move relative to the pipe body, thus changing the volume and pressure of the feed space; and the nozzle head is arranged at one end of the pipe body opposite to the piston, and configured to be driven to eject the foam material.

In one embodiment, the driving unit has a motor, a screw, a slider and a plurality of connecting rods; the motor is arranged on the body; one end of the screw is connected to the motor and driven by the motor to rotate in a direction of rotation; the slider movably arranged on the body and is in threaded connection with the screw, and can be driven by the screw to move in a direction close to or away from the injection pipe unit; one ends of the connecting rods are connected to the slider and the other ends are connected to the piston; thus, when the motor drives the screw to rotate, the slider will move synchronously to drive the piston to move.

In one embodiment, one of the auxiliary nozzle assemblies has a body, a feed unit, a motor, a feed screw and a nozzle head; the feed unit is arranged on one side of the body, and has a feed space inside and a feed inlet topside, the feed inlet being communicated with the feed space and configured to fill a powder material; one end of the feed screw is connected to the motor and the other end extends into the feed space of the feed unit, so that the feed screw is driven by the motor to rotate in a direction of rotation to stir the powder material in the feed space; and the nozzle head is arranged at one end of the feed unit opposite to the feed inlet, communicated with the feed space, and configured to be driven to eject the powder material stirred by the feed screw.

In one embodiment, the first connecting unit has a plurality of first junction portions; each of the second connecting units has a plurality of second junction portions corresponding to the first junction portions respectively; and when the first connecting unit of the coupler is in contact with the second connecting unit of one of the main nozzle assembly or the auxiliary nozzle assemblies, the first junction portions are movably coupled to the second junction portions.

In one embodiment, the movable mechanism includes an X-axis movable mechanism, a Y-axis movable mechanism and a Z-axis movable mechanism, where the X-axis movable mechanism and the Y-axis movable mechanism are respectively configured to control the coupler to move in an X-axis direction and a Y-axis direction, and the Z-axis movable mechanism is configured to control the carrying device to move in a Z-axis direction, where the X-axis direction, the Y-axis direction, and the Z-axis direction are orthogonal to each other

In one embodiment, the X-axis movable mechanism has an X-axis track and an X-axis linear slide; the X-axis track is arranged in the operating space of the frame in the X-axis direction, and the X-axis linear slide is arranged on the X-axis track and can be driven to move along the X-axis track in the X-axis direction; the Y-axis movable mechanism has two Y-axis tracks and two Y-axis linear slides; the two Y-axis tracks are respectively arranged on opposite two sides of the frame in the Y-axis direction, and the two Y-axis linear slides are respectively arranged on the two Y-axis tracks and respectively connected to both ends of the X-axis track, and can be driven to drive the X-axis track to move along the two Y-axis tracks in the Y-axis direction; the Z-axis movable mechanism has a Z-axis track and a Z-axis linear slide; the Z-axis track is arranged on the frame in the Z-axis direction, and the Z-axis linear slide is arranged on the Z-axis track and can be driven to move along the Z-axis track in the Z-axis direction.

In one embodiment, the coupler is not connected to the main nozzle assembly and the auxiliary nozzle assemblies under normal conditions.

In one embodiment, a hybrid additive manufacturing method of secondary functional material filled lattice structures includes the following steps: an importing step: importing a model of a lattice structure into a hybrid additive manufacturing device, where the hybrid additive manufacturing device comprises a frame, a main nozzle assembly, a plurality of auxiliary nozzle assemblies, a movable mechanism, a coupler and an operating platform, where the frame has an operating space inside; the main nozzle assembly and the auxiliary nozzle assemblies are respectively detachably arranged on the frame, where the main nozzle assembly is configured to eject a thermoplastic material, and the auxiliary nozzle assemblies are configured to eject different secondary functional materials; the movable mechanism is configured to drive the coupler and the operating platform to move relative to each other in a three-dimensional direction; and the coupler can be connected to any one of the nozzle assemblies and drive the nozzle assembly to move in the operating space; a main lattice structure generation step: moving the main nozzle assembly to the operating platform, and generating the lattice structure stacked by the thermoplastic material, where the lattice structure has a hollow lattice cavity; a nozzle replacement step: returning the connected nozzle assembly to the frame, and connecting one of the auxiliary nozzle assemblies; and a secondary functional material filling step: moving the connected auxiliary nozzle assembly to the operating platform and filling the secondary functional material into the lattice cavity of the lattice structure.

In one embodiment, the secondary functional material filling step is followed by a closed-cell lattice structure generation step: repeating the nozzle replacement step and the secondary functional material filling step for a predetermined number of times until the lattice cavity of the lattice structure is completely filled with at least one of the secondary functional materials, so that the lattice structure forms a closed-cell lattice structure.

In one embodiment, the secondary functional materials include at least one selected from the group consisting of a fluid material, a foam material, a powder material, a gel material, a slurry material, and a paste material.

According to the objectives, efficacies and structural configurations disclosed in the present invention, preferred embodiments are illustrated below, and described in detail with reference to the drawings.

### BRIEF DESCRIPTION OF THE DRAWINGS

FIG. 1 is a schematic diagram of a preferred embodiment of the present invention;

FIG. 2 is a schematic diagram of a preferred embodiment of the present invention after removal of part of side plates;

FIG. 3 is a schematic diagram of a main nozzle assembly according to a preferred embodiment of the present invention;

FIG. 4 is a schematic diagram of a first auxiliary nozzle assembly according to a preferred embodiment of the present invention;

FIG. 5 is a schematic diagram of a second auxiliary nozzle assembly according to a preferred embodiment of the present invention;

FIG. 6 is a schematic diagram of a third auxiliary nozzle assembly according to a preferred embodiment of the present invention;

FIG. 7 is a schematic diagram of a coupler according to a preferred embodiment of the present invention;

FIG. 8 is a schematic diagram of a lattice structure according to a preferred embodiment of the present invention;

FIG. 9 is a schematic diagram of a secondary functional material filled lattice structure according to a preferred embodiment of the present invention.

### DESCRIPTION OF REFERENCE NUMERALS

10: frame
11: bottom plate
12: upright
13: side plate
14: top plate
140: coupling member
15: operating space
20: main nozzle assembly
21: body
22: feed inlet
23: first heat dissipation unit
230: first fan
24: heating unit
25: nozzle head
26: second heat dissipation unit
260: second fan
261: airflow channel
30: first auxiliary nozzle assembly
31: body
32: roller assembly
33: motor
34: feed pipe
35: nozzle head
40: second auxiliary nozzle assembly
41: body
42: injection pipe unit
420: pipe body
421: piston
43: feed pipe
44: driving unit
440: motor
441: screw
442: slider
443: connecting rod
45: nozzle head
50: third auxiliary nozzle assembly
51: body
52: feed unit
520: feed inlet
53: motor
54: feed screw
55: nozzle head
60: movable mechanism
61: X-axis movable mechanism
610: X-axis track
611: X-axis linear slide
62: Y-axis movable mechanism
620: Y-axis track
621: Y-axis linear slide
63: Z-axis movable mechanism
630: Z-axis track
631: Z-axis linear slide
632: underbed
70: coupler
71: first connecting unit
710: first junction portion
711: first locating piece
72: second connecting unit
720: second junction portion
721: second locating piece
80: operating platform
90: basic unit lattice structure
91: lattice cavity
92: perforation
93: ring surface portion
94: curved surface portion
100: secondary functional material

### DETAILED DESCRIPTION

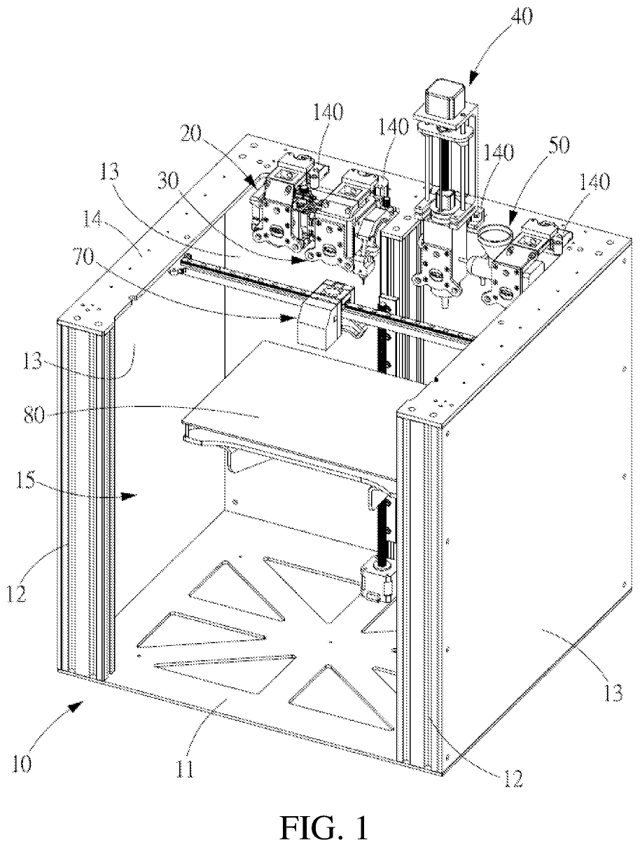

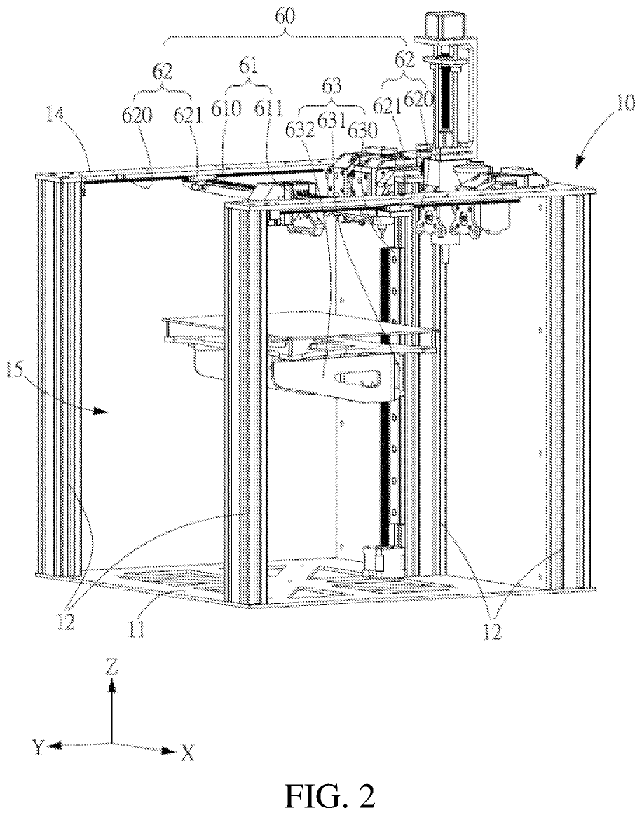

Referring to FIG. 1 and FIG. 2, a hybrid additive manufacturing device of secondary functional material filled lattice structures provided according to a preferred embodiment of the present invention mainly includes a frame 10, a main nozzle assembly 20, a first auxiliary nozzle assembly 30, a second auxiliary nozzle assembly 40, a third auxiliary nozzle assembly 50, a movable mechanism 60, a coupler 70 and an operating platform 80.

The frame 10 has a bottom plate 11, a plurality of uprights 12, a plurality of side plates 13 and a top plate 14. The bottom plate 11 is arranged on a bottom surface of the frame 10. One ends of the uprights 12 are respectively connected to an end of the bottom plate 11 and the other ends extend vertically in a direction away from the bottom plate 11. The side plates 13 are respectively arranged between the adjacent uprights 12 and perpendicular to the bottom plate 11. The top plate 14 is approximately in a shape of [symbol] , arranged on one side of the frame 10 opposite to the bottom plate 11 and connected to the other ends of the uprights 12 opposite to the bottom plate 11. A plurality of coupling members 140 are provided at the top plate 14. The bottom plate 11, the side plates 13 and the top plate 14 define an operating space 15 by enclosing. It's worth noting that in this embodiment, the frame 10 is a semi-open space having at least one side not closed by the side plates 13.

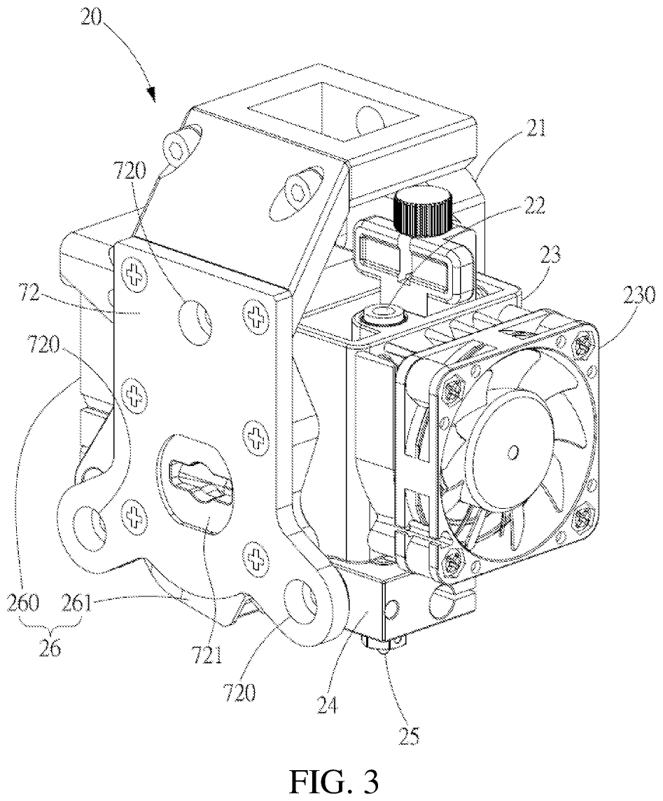

Referring to FIG. 3, the main nozzle assembly 20 is a fused filament modeling nozzle (FFF nozzle), and has a body 21, a feed inlet 22, a first heat dissipation unit 23, a heating unit 24, a nozzle head 25 and a second heat dissipation unit 26. The body 21 is detachably arranged on the frame 10 and connected to one of the coupling members 140. The feed inlet 22 is arranged on the body 21 and communicated with the nozzle head 25. The feed inlet 22 is configured to fill a filamentous thermoplastic material which may include, but is not limited to, various linear elastic or hyperelastic materials. In this embodiment, the feed inlet 22 is made of a polytetrafluoroethylene (PTFE) material. The first heat dissipation unit 23 is arranged below the feed inlet, the inside of the first heat dissipation unit 23 is communicated with the feed inlet 22, and a first fan 230 that is driven to reduce the heat energy transferred by the heating unit 24 to the inside of the first heat dissipation unit 23 so as to reduce the temperature inside the first heat dissipation unit 23 is provided on the outside of the first heat dissipation unit 23. The heating unit 24 is arranged between the first heat dissipation unit 23 and the nozzle head 25, and the inside of the heating unit 24 is respectively communicated with the inside of the first heat dissipation unit 23 and the nozzle head 25. The heating unit 24 is configured to provide heat energy to heat the thermoplastic material passing through the heating unit 24 to a predetermined temperature until the thermoplastic material is in a semi-molten state. The nozzle head 25 is detachably arranged below the body 21, disposed adjacent to the heating unit 24, and configured to be driven to eject the thermoplastic material heated to the semi-molten state by the heating unit 24. The second heat dissipation unit 26 has a second fan 260 and an airflow channel 261. The second fan 260 is arranged on one side of the body 21 opposite to the first heat dissipation unit 23, and configured to be driven to provide an air flow. The airflow channel 261 is a hollow curved shell with an end connected to the second fan 260 and the other end adjacent to the nozzle head 25, and configured to guide the air flow discharged by the second fan 260 to the nozzle head 25 to control the temperature of the nozzle head 25.

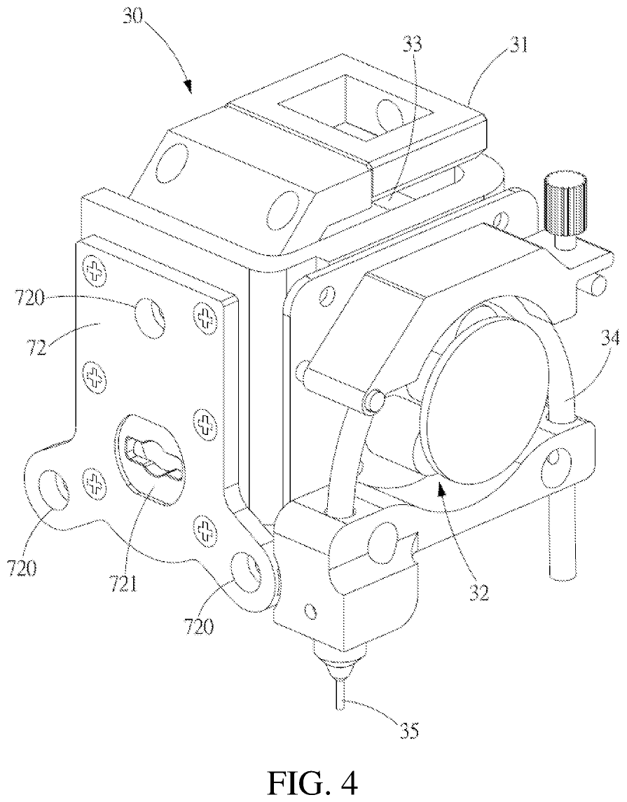

Referring to FIG. 4, the first auxiliary nozzle assembly 30 is a fluid filling nozzle configured to provide fluid-like secondary functional materials that include but are not limited to adhesives, glues, gels, photocurable resins, thermosetting resins, molten waxes and high-molecular polymers. The first auxiliary nozzle assembly 30 has a body 31, a roller assembly 32, a motor 33, a feed pipe 34 and a nozzle head 35. The body 31 is detachably arranged on the frame 10 and connected to one of the coupling members 140. The roller assembly 32 is rotatably arranged on one side of the body 31. The motor 33 is arranged on the body 31 and disposed adjacent to the roller assembly 32, and configured to be driven to drive the roller assembly 32 to rotate in a direction of rotation. In this embodiment, the motor 33 is a stepping motor. The feed pipe 34 is approximately curved around the roller assembly 32, and one end of the feed pipe 34 is connected to a fluid source (not shown) so that the fluid source can fill a fluid material into the feed pipe 34. The nozzle head 35 is arranged on the body 31 and communicated with the other end of the feed pipe 34 opposite to the fluid source, and configured to be driven to eject the fluid material. In another embodiment, the auxiliary nozzle assembly may also be provided with a heating unit adjacent to the nozzle head and configured to heat the fluid material.

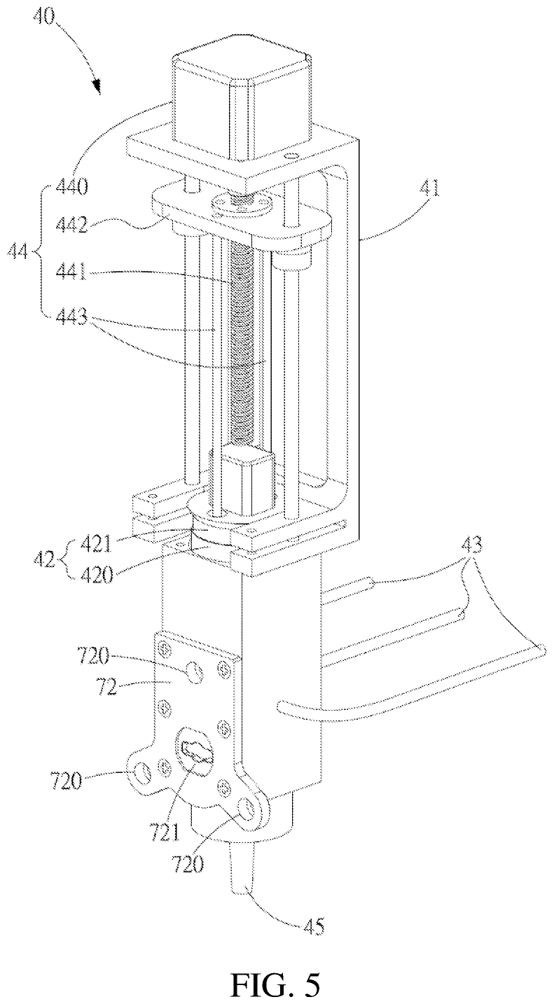

Referring to FIG. 5, the second auxiliary nozzle assembly 40 is a foam filling nozzle configured to provide foam-like secondary functional materials that include but are not limited to plastic polymers (ex: polyurethane (PU)), rubber polymers, resin polymers or natural polymer foam materials (ex: foamed starch, foamed plant fibers). The second auxiliary nozzle assembly 40 has a body 41, an injection pipe unit 42, a plurality of feed pipes 43, a driving unit 44 and a nozzle head 45. The body 41 is detachably arranged on the frame 10 and connected to one of the coupling members 140. The injection pipe unit 42 has a pipe body 420 and a piston 421. The pipe body 420 has a feed space (not shown) inside. The piston 421 extends into the feed space of the pipe body 420, one ends of the feed pipes 43 are respectively connected to the feed space of the injection pipe unit 42, the other ends are connected to at least one feed source (not shown), and the feed pipes 43 are driven to inject at least a foam material into the feed space of the pipe body 420. In this embodiment, some feed pipes 43 transport a polymer precursor solution containing a polymer structure, an initiator and a surfactant, and the remaining feed pipes 43 transport a gas. The driving unit 44 has a motor 440, a screw 441, a slider 442 and a plurality of connecting rods 443. The motor 440 is arranged above the body 41. One end of the screw 441 is connected to the motor 440, and driven by the motor 440 to rotate in a direction of rotation. The slider 442 is movably arranged on the body 41, is in threaded connection with the screw 441, and can be driven by the screw 441 to move in a direction close to or away from the injection pipe unit 42. One ends of the connecting rods 443 are connected to the slider 442, and the other ends are connected to the piston 421. Thus, when the motor 440 drives the screw 441 to rotate, the slider 442 will move synchronically to drive the piston 421 to move relative to the pipe body 420, thus changing the volume and pressure of the feed space, and then mixing the material in the feed space to form the foam material. The nozzle head 45 is arranged at one end of the pipe body 420 opposite to the piston 421, and driven to eject the foam material. In another embodiment, the second auxiliary nozzle assembly may also be provided with a heating unit adjacent to the nozzle head and configured to heat the foam material.

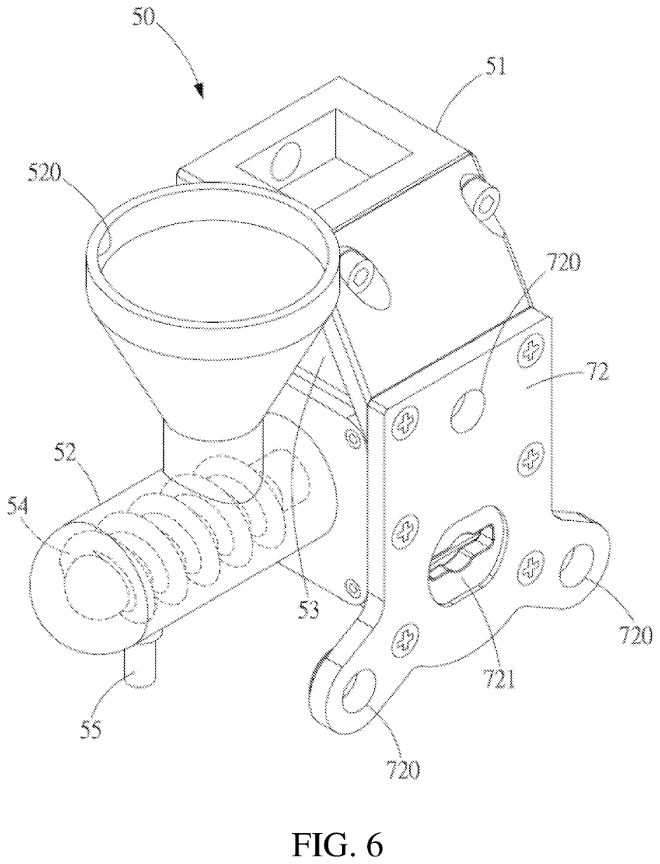

Referring to FIG. 6, the third auxiliary nozzle assembly 50 is a powder filling nozzle configured to provide powdered secondary functional materials that include but are not limited to metal powder, plastic-containing powder, glass powder, ceramic powder, polymer powder, etc. The third auxiliary nozzle assembly 50 has a body 51, a feed unit 52, a motor 53, a feed screw 54 and a nozzle head 55. The body 51 is detachably arranged on the frame 10 and connected to one of the coupling members 140. The feed unit 52 is arranged on one side of the body 51, and has a feed space (not shown) inside and a funnel-shaped feed inlet 520 topside, the feed inlet 520 being communicated with the feed space and configured to fill a powder material. The motor 53 is arranged on the body 51. One end of the feed screw 54 is connected to the motor 53, and the other end extends into the feed space of the feed unit 52, the feed screw 54 is driven by the motor 53 to rotate in a direction of rotation, so as to stir and homogenize the powder material in the feed space. In this embodiment, the feed screw 54 is a screw. The nozzle head 55 is arranged at one end of the feed unit 52 opposite to the feed inlet 520 and communicated with the feed space, and configured to be driven to eject the powder material stirred by the feed screw 54. In another embodiment, the third auxiliary nozzle assembly may also be provided with a heating unit adjacent to the nozzle head and configured to heat the powder material.

Referring to FIG. 1 and FIG. 2 again, the movable mechanism 60 includes an X-axis movable mechanism 61, a Y-axis movable mechanism 62, a Z-axis movable mechanism 63 and a control unit (not shown). The X-axis movable mechanism 61 and the Y-axis movable mechanism 62 are configured to control the coupler 70 to move in an X-axis direction and a Y-axis direction respectively, and the Z-axis movable mechanism 63 is configured to control the operating platform 80 to move in a Z-axis direction, so that the coupler 70 and the operating platform 80 can move relative to each other in a three-dimensional direction. The X-axis direction, the Y-axis direction, and the Z-axis direction are orthogonal to each other. The X-axis movable mechanism 61 has an X-axis track 610 and an X-axis linear slide 611. The X-axis track 610 is arranged in the operating space 15 of the frame 10 in the X-axis direction, and both ends of the X-axis track 610 are connected to the top plate 14. The X-axis linear slide 611 is movably arranged on the X-axis track 610 and can be driven to move along the X-axis track 610 in the X-axis direction. The Y-axis movable mechanism 62 has two Y-axis tracks 620 and two Y-axis linear slides 621. The two Y-axis tracks 620 are arranged in the operating space 15 of the frame 10 in the Y-axis direction, and respectively connected to opposite two sides of the top plate 14. The two Y-axis linear slides 621 are respectively arranged on the two Y-axis tracks 620 and respectively connected to both ends of the X-axis track 610, and can be driven to drive the X-axis track 610 to move along the two Y-axis track 620 in the Y-axis direction. The Z-axis movable mechanism 63 has a Z-axis track 630 and a Z-axis linear slide 631. The Z-axis track 630 is arranged in the operating space 15 of the frame 10 in the z-axis direction, and one end of the Z-axis track 630 is connected to the bottom plate 11. The Z-axis linear slide 631 is arranged on the Z-axis track 630 and can be driven to move along the Z-axis track 630 in the Z-axis direction. The Z-axis movable mechanism 63 further has an underbed 632 that is connected to the Z-axis linear slide 631 and can be moved synchronously along with the Z-axis linear slide 631. The control unit is electrically connected to the X-axis linear slide 611, the Y-axis linear slides 621 and the Z-axis linear slide 631, and configured to control the X-axis linear slide 611, the Y-axis linear slides 621 and the Z-axis linear slide 631 to operate according to program settings or manual adjustments.

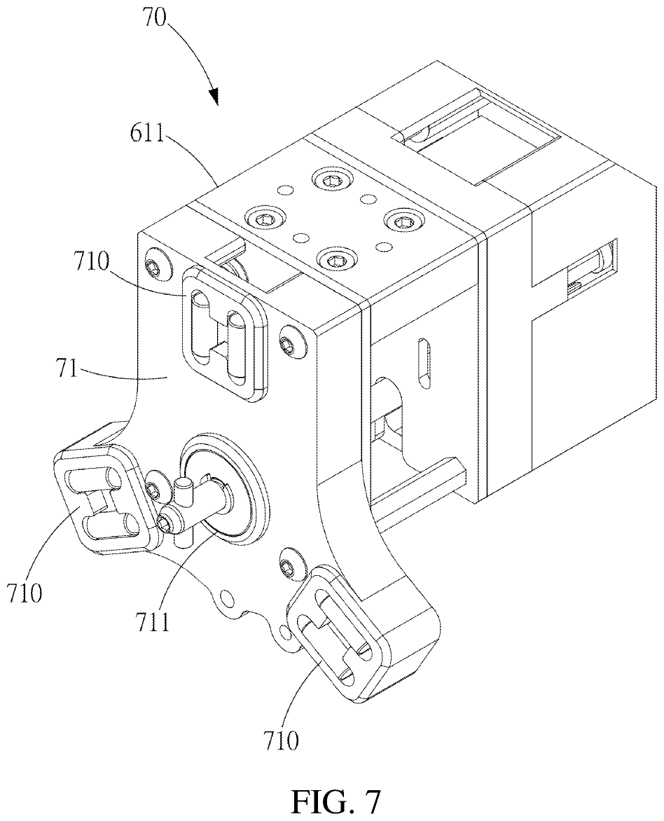

Referring to FIG. 7, the coupler 70 has a first connecting unit 71 configured to be driven to connect one of the main nozzle assembly 20, the first auxiliary nozzle assembly 30, the second auxiliary nozzle assembly 40 and the third auxiliary nozzle assembly 50 and to drive the one to move. However, under normal conditions, the coupler 70 is not connected to any one of the main nozzle assembly 20, the first auxiliary nozzle assembly 30, the second auxiliary nozzle assembly 40 and the third auxiliary nozzle assembly 50. In particular, the first connecting unit 71 is a herringbone plate and arranged on one side of the X-axis linear slide 611. The first connecting unit 71 is provided with a first junction portion 710 at each of three ends. In this embodiment, the first junction portion 710 is an H-shaped containing groove in which two cylinders separated by a predetermined distance may be arranged side by side. The first connecting unit 71 is further provided with a first locating piece 711 at the central position. In this embodiment, the first locating piece 71 is a through hole, and a combination of a convex column and a motor, that protrudes from the through hole, may be arranged. The motor is connected to the convex column to control the rotation of the convex column in a direction of rotation.

It should be specially noted that, as shown in FIGS. 2-5, the main nozzle assembly 20, the first auxiliary nozzle assembly 30, the second auxiliary nozzle assembly 40 and the third auxiliary nozzle assembly 50 each have a second connecting unit 72 corresponding to the first connecting unit 71. In particular, each of the second connecting units 72 is approximately a herringbone plate, and each is provided with a second junction portion 720 at a position corresponding to each of the first junction portions 710. In this embodiment, each of the second junction portions 720 is a circular containing groove in which a round bead (not shown) may be disposed. The second connecting unit 72 is further provided with a second locating piece 721 at a central position corresponding to the first locating piece 711. In this embodiment, the second locating piece 721 is an elongated hole whose shape corresponds to that of an end of the convex column of the first locating piece. Thus, when the coupler 70 is driven to be in contact with one of the main nozzle assembly 20, the first auxiliary nozzle assembly 30, the second auxiliary nozzle assembly 40 and the third auxiliary nozzle assembly 50 (hereinafter referred to as the nozzle assemblies 20, 30, 40, 50), the convex column of the first locating piece 711 can be embedded into the elongated hole of the second locating piece 721 and rotates an angle under the driving of the motor to restrain the first connecting unit 71 and the second connecting unit 72 from moving in a direction far from each other, and the two cylinders on each of the first junction portions 710 of the first connecting unit 71 are pressed against the round beads on the second junction portions 720 of the second connecting unit 72. Since there are two contact points between each of the round beads and the two cylinders, there are six contact points on the three beads in total, which is sufficient to restrain all 6 degrees of freedom of the first connecting unit 71 and the second connecting unit 72, so that a relative movement between the coupler 70 and one of the nozzle assemblies 20, 30, 40, 50 connected to the coupler 70 to form a kinematic coupling state cannot be achieved. Therefore, the coupler 70 can pull out and move one of the nozzle assemblies 20, 30, 40, 50 connected to the coupler 70 from the coupling member 140 of the frame 10. On the other hand, the coupler 70 may also be driven to reconnect one of the nozzle assemblies 20, 30, 40, 50 to the coupling member 140, and reversely driven by the motor to rotate an angle so that the convex column of the first locking piece 711 of the first connecting unit 71 is not embedded into the second locating piece 721 of the second connecting unit 72, in such a way, the first connecting unit 71 can leave the second connecting unit 72 to complete disconnection. In another embodiment, each of the first junction portions of the first connecting unit has a round bead and each of the second junction portions of the second connecting unit has two cylinders or other structures that can be meshed with each other. Also, in another embodiment, the first locating piece has an elongated hole and the second locating piece has a convex column or other structure that can be meshed with each other.

Referring to FIGS. 1 and 2 again, the operating platform 80 is located in the operating space 15, pressed against the underbed 632 of the movable mechanism 60, and configured to provide a surface on which one of the nozzle assemblies 20, 30, 40, 50 can perform 3D printing (additive manufacturing) or filling operations. The underbed 632 can be controlled by the Z-axis linear slide 631 to move up and down along the Z-axis track 630 in the Z-axis direction to adjust the relative position of the operating platform 80 and the coupler 70.

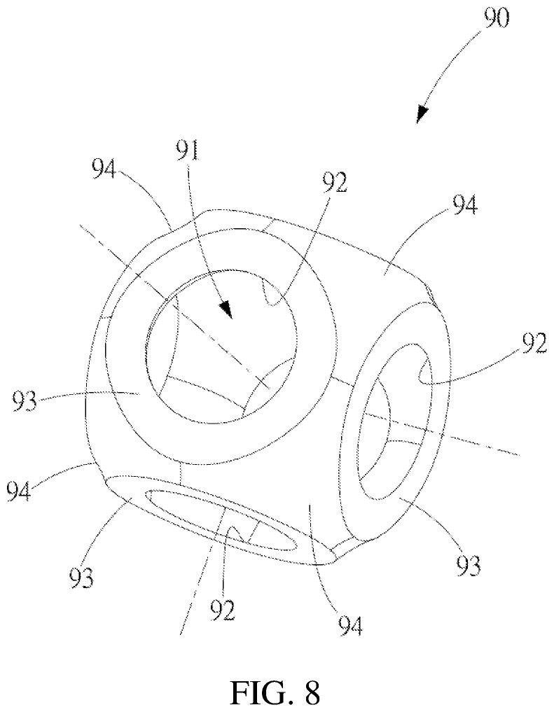

In this embodiment, the above-mentioned structural configuration uses the main nozzle assembly 20 to manufacture a tessellated lattice structure composed of at least one support-free lattice structure. As shown in FIG. 8, each of the lattice structures 90 is approximately in a shape of a sea urchin, between a sphere and a cube. The lattice structure 90 is a hollow open-cell lattice structure having a lattice cavity 91 inside, and the lattice structure 90 further has a plurality of perforations 92 respectively arranged on each side face of the lattice structure 90 and communicated with the lattice cavity 91. The perforations 92 are respectively arranged on three axes that are orthogonal to each other and pass through the center of the lattice structure 90, or in other words, the three axes that are orthogonal to each other and pass through the center of the lattice structure 90 may pass vertically through the center of the perforation 92. Therefore, in this embodiment, the lattice structure 90 has six perforations 92 in total, and two perforations 92 opposite to each other are arranged on each of the axes.

The lattice structure 90 further has a plurality of torus portions 93 and a plurality of cambered portions 94. In this embodiment, the torus portions 93 corresponds to the perforations 92 and each of the torus portions 93 surrounds the corresponding perforation 92. The torus portions 93, similar to the perforations 92, are respectively arranged on the three axes that are orthogonal to each other and pass through the center of the lattice structure 90. Therefore, in this embodiment, the lattice structure 90 has six torus portions 93 in total, and two torus portions 93 opposite to each other are arranged on each of the axes. The cambered portions 94 are approximately cambered, and respectively arranged on four diagonals that are intersected with each other and pass through the center of the lattice structure 90, the four diagonals are four diagonals corresponding to a cube, the four diagonals are equivalent to four diagonals of a lattice so that the four diagonals pass through the cambered portion 94. Therefore, the lattice structure 90 has eight cambered portions 94 in total, and two cambered portions 94 opposite to each other are arranged on each of the diagonals. Each of the cambered portions 94 is separately connected to three adjacent torus portions 93.

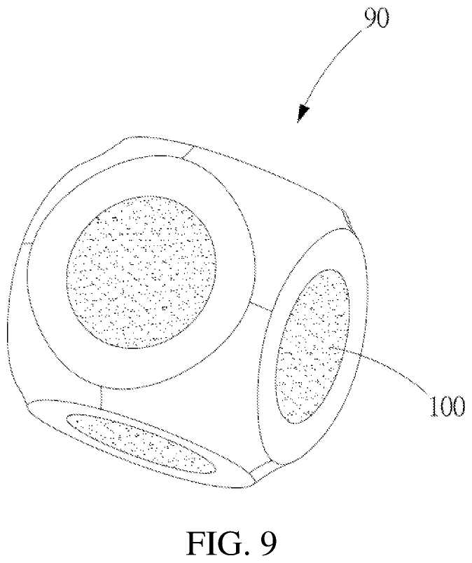

Further, the above-mentioned structural configuration uses the first auxiliary nozzle assembly 30, the second auxiliary nozzle assembly 40 and the third auxiliary nozzle assembly 50 to fill at least one secondary functional material 100 into the lattice cavity 91 of the lattice structure 90, so that the original open-cell lattice structure 90 forms a closed-cell lattice structure, as shown in FIG. 9. The filled secondary functional material 100 may be any one of the fluid material, the foam material, the powder material, or a combination thereof. In this way, the lattice structure 90 can be filled with corresponding secondary functional materials 100 according to different needs, which can, in addition to enhance the energy absorption and dissipation of the impact energy of the lattice structure, further can improve various functional properties (such as thermal insulation and electrical insulation, vibration and sound damping) of the original support-free lattice structure 90.

It should be added that only three secondary functional materials (fluid, foam, powder) are revealed in this embodiment. However, the present invention is not limited to the fluid material, the foam material or the powder material disclosed in this embodiment, and any other secondary functional materials (like a gel material, a slurry material and/or a paste material) capable of enhancing the functional properties of the lattice structure and nozzle structures using the secondary functional material do not depart from the application scope of the present invention.

According to the above structural configurations, a preferred embodiment of the present invention further provides a hybrid additive manufacturing method of secondary functional material filled lattice structures, comprising the following steps:
an importing step: a model of a lattice structure is imported into a hybrid additive manufacturing device. The model of the lattice structure may be composed of at least one lattice structure, for example, the model of the lattice structure may be a body-centered cubic tessellation, BCC) or a face-centered cubic tessellation (FCC), where the lattice structure is a support-free open-cell lattice structure. The hybrid additive manufacturing device includes a frame, a main nozzle assembly, a plurality of auxiliary nozzle assemblies, a movable mechanism, a coupler and an operating platform. The frame has an operating space inside. The main nozzle assembly and the auxiliary nozzle assemblies are respectively detachably arranged on the frame, where the main nozzle assembly is configured to eject a thermoplastic material, and the auxiliary nozzle assemblies are respectively configured to eject different secondary functional materials. The movable mechanism is configured to drive the coupler and the operating platform to move relative to each other in a three-dimensional direction. The coupler can be driven to connect any one of the nozzle assemblies and move the nozzle assembly to the operating space, or return the nozzle assembly to the frame.

A main lattice structure generation step: the main nozzle assembly is moved to the operating platform, and the lattice structure stacked by the thermoplastic material is generated, where the lattice structure has a hollow lattice cavity inside.

A nozzle replacement step: the connected nozzle assembly is returned to the frame, and one of the auxiliary nozzle assemblies is connected.

A secondary functional material filling step: the connected auxiliary nozzle assembly is moved to the operating platform, and the secondary functional material is filled into the lattice cavity of the lattice structure. The secondary functional material may be a fluid material, a foam material, a powder material or other similar material (like a gel material, a slurry material and/or a paste material).

A closed-cell lattice structure generation step: the nozzle replacement step and the secondary functional material filling step are repeated for a predetermined number of times until the lattice cavity of the lattice structure is completely filled with at least one of the secondary functional materials, so that the lattice structure forms a closed-cell lattice structure. The predetermined number of times can be freely adjusted according to material requirements or functional requirements.

In summary, according to the hybrid additive manufacturing device and the hybrid additive manufacturing method of secondary functional material filled lattice structures provided by the present invention, a closed-cell lattice structure filled with secondary functional materials can be generated by the detachable main nozzle assembly and the auxiliary nozzle assemblies capable of providing different secondary functional materials in the same device, so as to enhance the energy absorption and dissipation of the impact energy of the lattice structure, and provide additional functional properties of the lattice structure. On the other hand, according to the present invention, a concept of direct digital manufacturing is utilized to combine two processes of additive manufacturing and secondary material filling into one process, so that the decentralization of the manufacturing process is promoted, thereby reducing the lead time of manufacturing.

The foregoing embodiments are merely illustrative of the technologies of the present invention and the efficacies thereof, but are not intended to limit the present invention. The above-mentioned embodiments may be amended and varied by those skilled in the art without departing from the technical principle and spirit of the present invention. Therefore, the scope of protection of the claims of the present invention shall be the scope of patent application described later.

What is claimed is:

1. A hybrid additive manufacturing device of secondary functional material filled lattice structures, comprising:
a frame, having an operating space inside;
a main nozzle assembly, detachably arranged on the frame and configured to be driven to eject a thermoplastic material;
a plurality of auxiliary nozzle assemblies, detachably arranged on the frame respectively and configured to be driven to eject at least one secondary functional material;
a coupler, movably arranged in the operating space of the frame, wherein the coupler has a first connecting unit, and the main nozzle assembly and the auxiliary nozzle assemblies each have a second connecting unit corresponding to the first connecting unit of the coupler; and the coupler is driven to move by the first connecting unit in combination with the second connecting unit of one of the main nozzle assembly or the auxiliary nozzle assemblies;
an operating platform, arranged in the operating space of the frame; and
a movable mechanism, arranged on the frame, connected to the coupler and a carrying device, and configured to allow the coupler and the operating platform to move relative to each other in a three-dimensional direction;
thus, the coupler can be driven by the movable mechanism to connect the main nozzle assembly and move the main nozzle assembly to the operating platform to generate an support-free lattice structure formed by a thermoplastic material; and then the coupler can be driven by the movable mechanism to return the main nozzle assembly to the frame and connect one of the auxiliary nozzle assemblies to move the one to the operating platform to fill at least a secondary functional material into a lattice cavity inside the lattice structure, so that the lattice structure forms a closed-cell lattice structure.

2. The hybrid additive manufacturing device of secondary functional material filled lattice structures according to claim 1, wherein the main nozzle assembly has a body, a feed inlet, a first heat dissipation unit, a heating unit and a nozzle head; the feed inlet is formed on the body and configured to fill the thermoplastic material; the first heat dissipation unit is arranged on one side of the body, and the inside of the first heat dissipation unit is communicated with the feed inlet; the heating unit is arranged on one side of the first heat dissipation unit opposite the feed inlet, and communicated with the inside of the first heat dissipation unit; and the nozzle head is adjacent to the heating unit, and configured to be driven to eject the thermoplastic material that enters through the feed inlet and is heated by the heating unit.

3. The hybrid additive manufacturing device of secondary functional material filled lattice structures according to claim 2, wherein the main nozzle assembly further has a second fan and a hollow airflow channel; the second fan is arranged on one side of the body opposite to the first heat dissipation unit; and the airflow channel is arranged on the body, one end of the airflow channel is communicated with the second fan, and the other end is adjacent to the nozzle head.

4. The hybrid additive manufacturing device of secondary functional material filled lattice structures according to claim 1, wherein one of the auxiliary nozzle assemblies has a body, a roller assembly, a motor, a feed pipe and a nozzle head; the roller assembly is rotatably arranged on one side of the body; the motor is arranged on the body and adjacent to the roller assembly, and configured to be driven to drive the roller assembly to rotate in a direction of rotation; the feed pipe is approximately curved around the roller assembly, and one end of the feed pipe is connected to a fluid source so that the fluid source can fill a fluid material into the feed pipe; and the nozzle head is arranged on the body, communicated with the other end of the feed pipe opposite to the fluid source, and configured to be driven to eject the fluid material in the feed pipe.

5. The hybrid additive manufacturing device of secondary functional material filled lattice structures according to claim 1, wherein one of the auxiliary nozzle assemblies has an injection pipe unit, a plurality of feed pipes, a driving unit and a nozzle head; the injection pipe unit has a pipe body and a piston, the pipe body has a feed space inside, and one end of the piston extends into the feed space of the pipe body; one ends of the feed pipes are connected to at least one feed source, and the other ends are respectively connected to the feed space of the pipe body, so that the feed source can inject at least one foam material into the feed space of the pipe body along the feed pipes; the driving unit is connected to the piston, and configured to drive the piston to move relative to the pipe body, thus changing the volume and pressure of the feed space; and the nozzle head is arranged at one end of the pipe body opposite to the piston, and configured to be driven to eject the foam material.

6. The hybrid additive manufacturing device of secondary functional material filled lattice structures according to claim 5, wherein the driving unit has a motor, a screw, a slider and a plurality of connecting rods; the motor is arranged on the body; one end of the screw is connected to the motor and driven by the motor to rotate in a direction of rotation; the slider is movably arranged on the body and is in threaded connection with the screw, and can be driven by the screw to move in a direction close to or away from the injection pipe unit; one ends of the connecting rods are connected to the slider and the other ends are connected to the piston; thus, when the motor drives the screw to rotate, the slider will move synchronously to drive the piston to move.

7. The hybrid additive manufacturing device of secondary functional material filled lattice structures according to claim 1, wherein one of the auxiliary nozzle assemblies has a body, a feed unit, a motor, a feed screw and a nozzle head; the feed unit is arranged on one side of the body, and has a feed space inside and a feed inlet topside, the feed inlet being communicated with the feed space and configured to fill a powder material; one end of the feed screw is connected to the motor and the other end extends into the feed space of the feed unit, so that the feed screw is driven by the motor to rotate in a direction of rotation to stir the powder material in the feed space; and the nozzle head is arranged at one end of the feed unit opposite to the feed inlet, communicated with the feed space, and configured to be driven to eject the powder material stirred by the feed screw.

8. The hybrid additive manufacturing device of secondary functional material filled lattice structures according to claim 1, wherein the first connecting unit has a plurality of first junction portions; each of the second connecting units has a plurality of second junction portions corresponding to the first junction portions respectively; and when the first connecting unit of the coupler is in contact with the second connecting unit of one of the main nozzle assembly or the auxiliary nozzle assemblies, the first junction portions are movably coupled to the second junction portions.

9. The hybrid additive manufacturing device of secondary functional material filled lattice structures according to claim 1, wherein the movable mechanism comprises an X-axis movable mechanism, a Y-axis movable mechanism and a Z-axis movable mechanism, where the X-axis movable mechanism and the Y-axis movable mechanism are respectively configured to control the coupler to move in an X-axis direction and a Y-axis direction, and the Z-axis movable mechanism is configured to control the carrying device to move in a Z-axis direction, where the X-axis direction, the Y-axis direction, and the Z-axis direction are orthogonal to each other.

10. The hybrid additive manufacturing device of secondary functional material filled lattice structures according to claim 9, wherein the X-axis movable mechanism has an X-axis track and an X-axis linear slide; the X-axis track is arranged in the operating space of the frame in the X-axis direction, and the X-axis linear slide is arranged on the X-axis track and can be driven to move along the X-axis track in the X-axis direction; the Y-axis movable mechanism has two Y-axis tracks and two Y-axis linear slides; the two Y-axis tracks are respectively arranged on opposite two sides of the frame in the Y-axis direction, and the two Y-axis linear slides are respectively arranged on the two Y-axis tracks and respectively connected to both ends of the X-axis track, and can be driven to drive the X-axis track to move along the two Y-axis tracks in the Y-axis direction; the Z-axis movable mechanism has a Z-axis track and a Z-axis linear slide; the Z-axis track is arranged on the frame in the Z-axis direction, and the Z-axis linear slide is arranged on the Z-axis track and can be driven to move along the Z-axis track in the Z-axis direction.

11. The hybrid additive manufacturing device of secondary functional material filled lattice structures according to claim 1, wherein the coupler is not connected to the main nozzle assembly and the auxiliary nozzle assemblies under normal conditions.

12. A hybrid additive manufacturing method of secondary functional material filled lattice structures, comprising the following steps:
an importing step: importing a model of a lattice structure into a hybrid additive manufacturing device, where the hybrid additive manufacturing device comprises a frame, a main nozzle assembly, a plurality of auxiliary nozzle assemblies, a movable mechanism, a coupler and an operating platform, where the frame has an operating space inside; the main nozzle assembly and the auxiliary nozzle assemblies are respectively detachably arranged on the frame, where the main nozzle assembly is configured to eject a thermoplastic material, and the auxiliary nozzle assemblies are configured to eject different secondary functional materials; the movable mechanism is configured to drive the coupler and the operating platform to move relative to each other in a three-dimensional direction; and the coupler can be connected to any one of the nozzle assemblies and drive the nozzle assembly to move in the operating space;
a main lattice structure generation step: moving the main nozzle assembly to the operating platform, and generating the lattice structure stacked by the thermoplastic material, where the lattice structure has a hollow lattice cavity;
a nozzle replacement step: returning the connected nozzle assembly to the frame, and connecting one of the auxiliary nozzle assemblies; and
a secondary functional material filling step: moving the connected auxiliary nozzle assembly to the operating platform and filling the secondary functional material into the lattice cavity of the lattice structure.

13. The hybrid additive manufacturing method of secondary functional material filled lattice structures according to claim 12, wherein the secondary functional material filling step is followed by a closed-cell lattice structure generation step: repeating the nozzle replacement step and the secondary functional material filling step for a predetermined number of times until the lattice cavity of the lattice structure is completely filled with at least one of the secondary functional materials, so that the lattice structure forms a closed-cell lattice structure.

14. The hybrid additive manufacturing method of secondary functional material filled lattice structures according to claim 12, wherein the secondary functional materials comprise at least one selected from the group consisting of a fluid material, a foam material, a powder material, a gel material, a slurry material, and a paste material.
